(19) United States
(12) Patent Application Publication
(10) Pub. No.: US 2006/0104666 A1
(43) Pub. Date: May 18, 2006

(54) Developing unit driving device and image forming apparatus having the same

(75) Inventor: Young-Min Yoon, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/249,303

(22) Filed: Oct. 14, 2005

(30) Foreign Application Priority Data
Nov. 12, 2004 (KR) 2004-0092335

(51) Int. Cl. G03G 15/01

(52) U.S. Cl. 399/228

(57) ABSTRACT

A developing unit driving device and an image forming apparatus having the same is provided. The developing unit driving device includes a high voltage applying substrate, a reciprocating pusher unit that allows the first terminal and the second terminal formed on the high voltage applying substrate to contact and separate from each other, a power transmitting unit that transmits power supplied from a power source to the reciprocating pusher unit by connecting with the reciprocating pusher unit, and a power control unit provided between a power source and the power transmitting unit that controls power to transmit to a corresponding developing unit.

### CROSS-REFERENCE TO RELATED APPLICATIONS

This application claims the benefit under 35 U.S.C. § 119(a) of Korean Patent Application No. 10-2004-0092335, filed on Nov. 12, 2004, the entire disclosure of which is hereby incorporated by reference.

### BACKGROUND OF THE INVENTION

1. Field of the Invention

The present invention relates to an image forming apparatus. More particularly, the present invention relates to a driving device for a developing unit that can develop an electrostatic latent image formed on a photosensitive medium into a predetermined color by selectively driving a plurality of developing units, and an image forming apparatus having the driving device.

2. Description of the Related Art

Generally, an image forming apparatus performs the following processes: a charging process that charges a predetermined potential on a surface of a photosensitive medium. An exposing process forms an electrostatic latent image on the surface of the photosensitive medium by irradiating the surface of the photosensitive medium with light from a light scanning unit such as laser scanning unit (LSU). A developing process develops the electrostatic latent image formed on the surface of the photosensitive medium into a visible toner image by supplying toner as an developing agent. A paper supplying process removes a piece of paper from a paper supply cassette and supplies the piece of paper through a paper conveying route. A transferring process transfers the toner image formed on the photosensitive medium onto the supplied piece of paper. A fixing process that fixes the toner image onto the piece of paper by applying high temperature and pressure. A paper discharging process discharges the piece of paper on which the toner image is fixed from the image forming apparatus.

In an image forming apparatus that forms an image on a piece of paper according to the above described method, the developing process employs a method in which the toner of the developing unit is transferred to the photosensitive medium by a potential difference between the developing unit and the photosensitive medium. For this process, high voltage must be applied to a selected developing unit or to each of four developing units sequentially.

A device that applies high voltage to a developing unit which is employed in a conventional color image forming apparatus is depicted in FIGS. 1 and 2.

In FIGS. 1 and 2, reference numerals 80, 82 and 83 respectively refer to a photosensitive drum, a developing unit, and a driving device for applying a high voltage. As described above, a conventional image forming apparatus includes four developing units, for example, one for each color. However, since the four developing units all have the same structure and operating principles, only one developing unit will be described for clarity and conciseness.

As depicted in FIG. 1, the four developing units 82 are mounted to sequentially contact a photosensitive drum 80. As depicted in FIG. 2, each of the developing units 82 includes a developing roller 90 and a toner supplying roller 92. The driving device 83 for applying a high voltage includes a motor 86 and a cam 84. The driving device 83 is disposed on a rear side of each of the developing units 82. The driving device 83 moves the corresponding developing unit 82 to the photosensitive drum 80 so that the developing roller 90 approaches the photosensitive drum 80. Therefore, the toner of the developing roller 90 can be transferred to the photosensitive drum 80.

A high voltage terminal 88, that generates the electric potential necessary for developing using the photosensitive drum 80 and the developing roller 90, is mounted on a frame (not shown). With this arrangement, when the developing unit 82 is forwarded to the photosensitive drum 80 by the driving device 83, an axis of the developing roller 90 contacts the high voltage terminal 88 causing a high voltage to be applied to the developing roller 90. Thus, the toner is transferred to the photosensitive drum 80 by a resulting electrostatic force. Afterward, the developing unit 82 reciprocates via a restoration spring 94 mounted on a rear of the developing unit 82 and developing is implemented using a different color of toner via a different developing unit forwarded by the driving device 83. The electrostatic latent image of the photosensitive drum 80 is developed with each color of toner by sequentially moving the developing unit 82 of each color through a series of operations.

However, the conventional device for applying a high voltage to a developing unit employs a method in which the developing unit moves back and forth with respect to the photosensitive drum 80 using a driving device composed of a motor 86 and a cam 84. Therefore, since the developing unit contacts the photosensitive drum periodically, the movement of the developing unit generates vibrations and load variations when the photosensitive drum rotates. These factors may change the speed of the photosensitive drum, which may cause problems such as generating errors in the color image.

Also, the conventional moving type high voltage applying device is very complicated and has numerous wires for applying high voltage to the developing units.

The conventional moving-type high voltage applying device can provide stable image quality by maintaining a proper developing nip when the moving distance of the developing unit is constant. However, when the driving device wears after many hours of operation, the moving distance of the developing unit may vary, thus failing to, maintain a proper developing nip and deteriorating image quality.

Also, the manufacturing cost of the conventional moving-type high voltage applying device of a developing unit is relatively high since it requires many parts such as a motor and a cam for moving the developing unit and groove sensors for driving the developing units sequentially for each color. It also requires an additional motor for driving the high voltage applying device itself.

Alternatively, although not shown in the drawings, high voltage can be applied to the developing unit using a solenoid. However, as a solenoid is required for each developing unit, the manufacturing cost of the image forming apparatus increases considerably.

Accordingly, there is a need for an improved image forming apparatus including a developing unit driving device which prevents load variations applied to a photosensitive medium due to vibrations.

### SUMMARY OF THE INVENTION

An aspect of the present invention is to address at least the above problems and/or disadvantages and to provide at least the advantages described below. Accordingly, an aspect of the present invention is to provide a developing unit driving device that can prevent load variations applied to a photosensitive medium due to the vibration of the developing unit, and an image forming apparatus having the same.

Another aspect of the invention is to provide a developing unit driving device that can apply a high voltage selectively to each of a plurality of developing units using a developing unit driving device without a solenoid or other additional device, and an image forming apparatus having the same.

The present invention also provides a developing unit driving device that can simplify manufacture of the developing unit by removing wires for applying high voltage to developing units, and an image forming apparatus having the same.

According to an aspect of the present invention, there is provided a developing unit driving device of an image forming apparatus that develops an electrostatic latent image formed on a photosensitive medium into predetermined colors by driving a plurality of developing units. The developing unit driving device comprises a high voltage applying substrate that includes a high voltage circuit connected to a high voltage power supply unit, a terminal unit connected to a high voltage applying terminal provided in each developing unit, a switch that controls high voltage supplied from the outside connected to the terminal unit and the high voltage circuit, and the switch has first and second terminals corresponding to each other. A reciprocating pusher unit connects and separates the first terminal and the second terminal by interacting with an end of the first terminal. A power transmitting unit transmits power supplied from a power source to the reciprocating pusher unit in connection with the reciprocating pusher unit and a power control unit disposed between the power source and the power transmitting unit controls power that is transmitted to the corresponding developing unit.

It is preferable that in the developing unit driving device the first terminal is connected to the terminal unit and the second terminal is connected to the high voltage circuit.

Preferably, the first terminal includes a contact end part corresponding to the second terminal and the contact end part is made to contact and separate from the second terminal by the reciprocating pusher unit.

Preferably, in the developing unit driving device, a terminal unit is mounted on a side surface of the high voltage applying substrate and the first and second terminals are mounted on the other side surface of the high voltage applying substrate.

Preferably, the first terminal is a contact spring.

Preferably, the power control unit includes an electronic clutch.

Preferably, the reciprocating pusher unit comprises a first member mounted on an axis that receives power from the power transmitting unit. A second member is mounted on the same axis as the first member and interacts with the contact end part so that the first terminal can selectively contact the second terminal by sliding back and forth along the axis in connection with the first member.

Preferably, in the developing unit driving device, a cam lobe pushes the second member to the contact end part when the first member rotates via a protrusion formed on an inner surface of the first member and the cam lobe is formed on an inner surface of the second member corresponding to the protrusion.

Preferably, the first terminal reciprocates the second member by an elastic restoration force generated by elastically biasing the second member toward the first member.

Preferably, the terminal unit of the high voltage applying substrate and the high voltage applying terminal of the developing unit are closely connected by a spring terminal.

Preferably, the first member is a gear.

Preferably, the power transmitting unit includes a power transmission gear that transmits power to the reciprocating pusher unit, wherein the reciprocating pusher unit includes an axis, a driven gear mounted on the axis that slides back and forth along the axis by gearing with the power transmission gear, and an interaction unit protruding from a side of the driven gear that interacts with the contact end part so that the first terminal can selectively contact the second terminal.

Preferably, the power transmission gear and the driven gear are helical gears.

Preferably, the terminal unit of the high voltage applying substrate and the high voltage applying terminal of the developing unit are closely connected by a spring terminal.

Preferably, the developing units are mounted a predetermined distance apart from the photosensitive medium.

According to another aspect of the present invention, there is provided an image forming apparatus including a developing unit driving device that develops an electrostatic latent image formed on a photosensitive medium into predetermined colors by selectively driving a plurality of developing units. The developing unit driving device comprises a high voltage applying substrate that includes a high voltage circuit connected to a high voltage power supply unit, a terminal unit connected to a high voltage applying terminal provided in each developing unit, a switch that controls high voltage supplied from the outside connected to the terminal unit and the high voltage circuit and has first and second terminals corresponding to each other. A reciprocating pusher unit connects and separates the first terminal and the second terminal by interacting with an end of the first terminal. A power transmitting unit transmits power supplied from a power source to the reciprocating pusher unit in connection with the reciprocating pusher unit and a power control unit disposed between the power source and the power transmitting unit controls power transmitted to the corresponding developing unit.

Preferably, the first terminal is connected to the terminal unit and the second terminal is connected to the high voltage circuit.

Preferably, the reciprocating pusher unit includes a first member, mounted on an axis that receives power from the power transmitting unit, and a second member, mounted on the same axis, that interacts with the contact end part so that the first terminal can selectively contact the second terminal by sliding back and forth along the axis in connection with the first member.

Preferably, a cam lobe pushes the second member to the contact end part when the first member rotates since a protrusion is formed on an inner surface of the first member and the cam lobe is formed on an inner surface of the second member corresponding to the protrusion.

Preferably, the power transmitting unit includes a power transmission gear that transmits power to the reciprocating pusher unit. The reciprocating pusher unit includes an axis, a driven gear mounted on the axis that slides back and forth along the axis by gearing with the power transmission gear, and an interaction unit protruding from a side of the driven gear that interacts with the contact end part so that the first terminal can selectively contact the second terminal.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a cross-sectional view illustrating a high voltage applying device of a developing unit employed in a conventional image forming apparatus;

FIG. 2 is an enlarged cross-sectional view of the high voltage applying device of FIG. 1;

FIG. 3 is a cross-sectional view illustrating an image forming apparatus according to an embodiment of the present invention;

FIG. 4 is a perspective view of a developing unit driving device according to an embodiment of the present invention;

FIG. 5 is a schematic drawing showing a connection state between the high voltage applying substrate of FIG. 4 and a developing unit;

FIG. 6 is a perspective view of an example of a reciprocating pusher unit of FIG. 4;

FIG. 7 is a plan view of the reciprocating pusher unit of FIG. 6;

FIG. 8 is a perspective view showing an operation of the reciprocating pusher unit of FIG. 6;

FIG. 9 is a plan view of the reciprocating pusher unit of FIG. 8;

FIG. 10 is a perspective view of another example of the reciprocating pusher unit of FIG. 4;

FIG. 11 is a plan view of the reciprocating pusher unit of FIG. 10;

FIG. 12 is a perspective view showing an operation of the reciprocating pusher unit of FIG. 10; and

FIG. 13 is a plan view of the reciprocating pusher unit of FIG. 10.

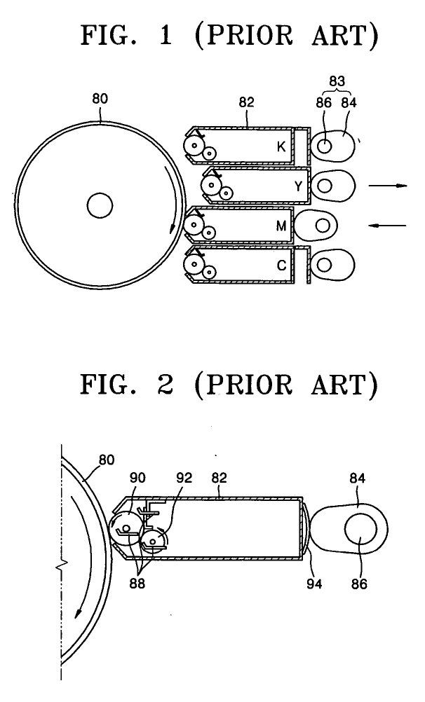

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

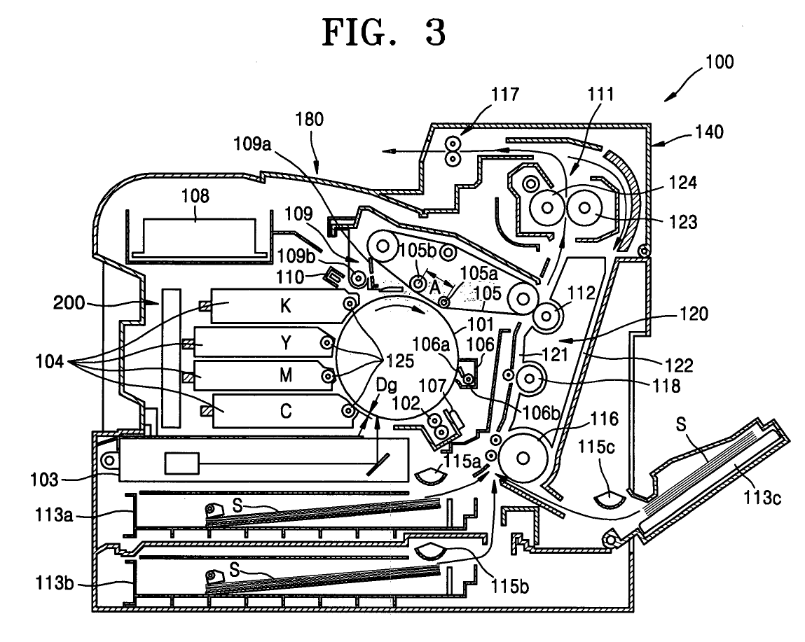

FIG. 3 is a cross-sectional view illustrating an image forming apparatus according to an embodiment of the present invention.

Referring to FIG. 3, an image forming apparatus 100 having a developing unit driving device 200 includes a photosensitive medium 101, a charge roller 102, a light scanning unit 103, four developing units 104, and a transfer belt 105, arranged in frame 140.

The photosensitive medium 101 is a cylindrical metal drum with a light conductive material layer deposited on its outer surface, and is mounted so that a portion of its outer surface is exposed. The photosensitive medium 101 is rotated in a predetermined direction, and an electrostatic latent image corresponding to an image to be printed is formed on its outer surface by irradiation from a light scanning unit 103, which will be described later.

The charge roller 102 is an example of a charging device that charges the photosensitive medium 101 to a uniform potential. The charge roller 102 supplies a charge to the outer surface of the photosensitive medium 101 either by contacting or by not contacting the outer surface of the photosensitive medium 101. A charge bias for charging the outer surface of the photosensitive medium 101 to a uniform potential is applied to the charge roller 102. A corona charger (not shown) can be employed instead of the charge roller 102.

The light scanning unit 103 is mounted below the photosensitive medium 101 and forms an electrostatic latent image on the outer surface of the photosensitive medium 101 which is charged to a uniform potential by scanning the outer surface of the photosensitive medium 101 with light corresponding to image information. The light scanning unit 103 includes a light source (not shown) that radiates a laser beam and a beam deflector that deflects the laser beam radiated from the light source. A laser scanning unit (LSU), which uses a laser diode as the light source, is used as the light scanning unit 103.

The four developing units 104C, 104M, 104Y, and 104K are formed as detachable cartridges mounted in the main frame 140. Solid powder toners of cyan (C), magenta (M), yellow (Y), and black (K) colors fill each of the developing units 104. Each of the four developing units 104C, 104M, 104Y, and 104K includes a developing roller 125 that forms a toner image by supplying toner to an electrostatic latent image formed on the outer surface of the photosensitive medium 101. The developing units 104C, 104M, 104Y, and 104K are replaced when the toner they contain is exhausted.

A developing roller 125 supplies the toner accommodated in the developing units to the photosensitive medium 101 by causing the toner to adhere to an outer surface of the developing roller 125. The developing roller 125 accommodates solid powder toner and develops a toner image by supplying the solid powder toner to an electrostatic latent image formed on the photosensitive medium 101. A developing bias voltage for supplying the toner to the photosensitive medium 101 is applied to the developing roller 125.

The four developing units 104C, 104M, 104Y, and 104K are mounted so that the developing rollers 125 can be separated by a predetermined distance, for example, a developing gap Dg, from an outer surface of the photosensitive medium 101. Alternatively, the developing rollers 125 can contact the outer surface of the photosensitive medium 101. A force which transfers toner from the photosensitive medium 101 to the developing roller 125 is generated by an electric field, and the charged toner is transferred by vibrational movement in a developing region formed within the developing gap Dg.

The developing unit driving device 200 selectively drives the four developing units 104C, 104M, 104Y, and 104K and is mounted on a side of the four developing units 104C, 104M, 104Y, and 104K.

A cyan developing unit 104C, a magenta developing unit 104M, a yellow developing unit 104Y, and a black developing unit 104K are sequentially disposed from bottom to top. A pre-transfer eraser 110 is disposed above the black developing unit 104K. The light scanning unit 103 and an erasing lamp 107 are disposed below the photosensitive medium 101. A paper conveying unit 120 is mounted on the opposite side of the photosensitive medium 101 from the developing units 104C, 104M, 104Y, and 104K.

Toner images of cyan (C), magenta (M), yellow (Y), and black (K) colors are sequentially formed on the photosensitive medium 101 and are transferred onto the transfer belt 105. A color toner image is formed by sequentially transferring the toner images onto the transfer belt 105. Generally, the length of the transfer belt 105 must be equal to or greater than the length of a piece of paper S onto which the color toner image is finally printed.

A plurality of supporting rollers support and rotate the transfer belt 105 in a predetermined direction and are formed on an inner surface of the transfer belt 105.

A nip roller 105a is installed at the inner surface of the transfer belt 105 to maintain a predetermined nip A between the photosensitive medium 101 and the transfer belt 105. A first transferring bias voltage is applied to an intermediate transfer roller 304 for transferring a toner image formed on the photosensitive medium 101 to the transfer belt 105.

The transfer belt 105 is mounted to face the photosensitive medium 101 in a space between the intermediate transfer roller 105b and the nip roller 105a. Thus, the toner image formed on the outer surface of the photosensitive medium 101 can be transferred to the transfer belt 105. The transfer belt 105 travels along a predetermined closed path supported by the plurality of supporting rollers, and the toner image developed on the outer surface of the photosensitive medium 101 is transferred onto the transfer belt 105.

A first cleaning device 106 includes a first blade that scrapes off unused toner remaining on the surface of the photosensitive medium 101 after a transferring process. A first conveying member 106a conveys the recovered unused toner to an unused toner storage (not shown).

A second cleaning device 109 removes unused toner remaining on the transfer belt 105 after the toner image is transferred onto the paper. The second cleaning device 109 includes a second blade that scrapes off the unused toner and a second conveying member 109b that conveys the recovered unused toner to an unused toner storage (not shown).

The transfer roller 112 is installed to face a surface of the transfer belt 105 onto which the toner image is transferred. A transferring bias voltage having an opposite polarity to the toner image is applied to the transfer roller 112 so that the toner image transferred onto the transfer belt 105 can be transferred to the piece of paper S. The toner image is transferred onto the piece of paper S by an electrostatic force which acts between the transfer belt 105 and the transfer roller 112. The transfer roller 112 separates from the transfer belt 105 while a color toner image is transferred onto the transfer belt 105. The transfer roller 112 is brought into contact with the transfer belt 105 via a predetermined pressure for the subsequent transferring of the color toner image onto the piece of paper S. Also, the toner image transferred onto the outer surface of the transfer belt 105 can be transferred onto the piece of paper S that passes between the transfer roller 112 and the transfer belt 105 by a contact pressure applied between the transfer belt 105 and the transfer roller 112.

The pre-transfer eraser 110 removes charges on a non-image region where no toner image is formed prior to transferring the toner image from the photosensitive medium 101 to the transfer belt 105. The pre-transfer eraser 110 is installed to increase the efficiency of transferring from the photosensitive medium 101 to the transfer belt 105.

The erasing lamp 107 is preferably the type of eraser that removes charges remaining on the outer surface of the photosensitive medium 101 in a pre-charge step. The erasing lamp 107 removes charges remaining on the surface of the photosensitive medium 101 by irradiating the surface of the photosensitive medium 101 with light of a predetermined intensity.

A high voltage power supply unit 108 supplies a developing bias voltage for transferring toner from the developing unit 104 to the photosensitive medium 101. A development preventing bias voltage for preventing the transfer of toner from the developing unit 104 to the photosensitive medium 101, a first transferring bias voltage for transferring a toner image from the photosensitive medium 101 to the transfer belt 105, a second transferring bias voltage for transferring a toner image from the transfer belt 105 to a piece of paper S, and a charge bias voltage supplied between the charge roller 102 are provided and located in the image forming apparatus.

A fixing unit 111 includes a heat roller 123 and a press roller 124 installed facing the heat roller 123 to fix a toner image onto a piece of paper S by applying heat and pressure to the toner image transferred onto the piece of paper S. The heat roller 123 is a heat source for fixing the toner image permanently and is installed facing the press roller 124 in an axial direction. The press roller 124 is installed facing the heat roller 123 and fixes the toner image onto the piece of paper S by applying a high pressure to the piece of paper S.

A paper discharge roller 117 discharges a piece of paper S, on which an image is fixed, to the outside of the image forming apparatus. The piece of paper S discharged from the image forming apparatus is stacked on a paper deck 180.

Reference numeral 113a indicates a paper supply cassette as an example of a stacking member on which the papers S are stacked. The stacking member can include a second paper supply cassette 113b and a multi-purpose feeder (MPF) 113c that can additionally stack paper. The MPF is mainly used for feeding OHP paper or paper of an unspecified size.

A feed roller 116 conveys pieces of paper S withdrawn from a paper supply cassette 113a, 113b, and 113c by pickup rollers 115a, 115b, and 115c to a paper conveying unit 120.

The paper conveying unit 120 includes a paper path 121 that guides a piece of paper S between the feed roller 116 and fixing unit 111, and a duplex path 122 for dual-sided printing. A paper registration roller 118 is mounted on the paper conveying unit 120. The paper registration roller 118 registers a piece of paper S so that a toner image can be transferred onto a desired position of the piece of paper S before passing between the transfer belt 105 and the transfer roller 112. The conveyed piece of paper S receives a toner image while passing between the transfer belt 105 and the transfer roller 112. The toner image transferred onto the piece of paper S is fixed thereto by the fixing unit 111 and discharged from the image forming apparatus 100 by the paper discharge roller 117.

The paper discharge roller 117 is rotated in reverse for dual-sided printing and the piece of paper S is conveyed along a reverse path 122. The piece of paper S is reversed so that an image can be printed on a second surface on which does not have an image. The image is then printed on the second surface of the reversed piece of paper S while the piece of paper S is conveyed through the paper path 121 by the feed roller 116.

The operation of the image forming apparatus according to an embodiment of the present invention will now be described in detail.

Color image information is a mixture of information corresponding to each of cyan (C), magenta (M), yellow (Y), and black (K) colors. In the present embodiment, each toner image of cyan (C), magenta (M), yellow (Y), and black (K) colors is sequentially overlapped on the transfer belt 105, and then a color image is formed by transferring and fixing the composite toner image from the transfer belt 105 onto a piece of paper S.

An outer surface of the photosensitive medium 101 is charged to a uniform potential by the charge roller 102. When a light signal corresponding to image information of the cyan C color is radiated onto the rotating photosensitive medium 101 by the light scanning unit 103, charges which adhere to an outer surface of the irradiated photosensitive medium 101 are reduced as resistance is reduced. Accordingly, a potential difference is generated between an irradiated part and a part that was not irradiated. An electrostatic latent image is formed on the outer surface of the photosensitive medium 101 by the potential difference.

The developing roller 125 of the cyan developing unit 104C begins to rotate when an electrostatic latent image approaches the cyan developing unit 104C due to rotation of the photosensitive medium 101. A developing bias voltage is applied to the developing roller 125 of the cyan developing unit 104C from the high voltage power supply 108. However, a development preventing bias voltage that prevents developing is applied to the developing roller 125 of the rest of the developing units 104M, 104Y, and 104K. At this time, only the toner of cyan C color adheres to the electrostatic latent image formed on the outer surface of the photosensitive medium 101 across the developing gap Dg, thereby forming a toner image of cyan C color.

When the toner of cyan C approaches the transfer belt 10S due to rotation of the photosensitive medium 101, the toner image is transferred onto the transfer belt 105 by a first transferring bias voltage or a contact pressure between the transfer belt 105 and the photosensitive medium 101.

When the toner of cyan C is completely transferred onto the transfer belt 105, toners of magenta (M), yellow (Y), and black (K) are sequentially transferred onto the transfer belt 105 through the same steps as described above for cyan (C) toner. At this time, the developing driving device 200 drives the developing units 104C, 104M, 104Y, and 104K so that the developing can be performed through the aforementioned steps.

In the above process, the transfer roller 112 is separated from the transfer belt 105. When a color toner image is formed on the transfer belt 105 by sequentially transferring the toners of all four colors, the transfer roller 112 contacts the transfer belt 105 to transfer the color toner image to a piece of paper S.

A piece of paper S is supplied from the paper supply cassette 113a (or 113b) or the MPF 113c to the transfer belt 105 such that an end of the piece of paper S reaches a point where the transfer belt 105 and the transfer roller 112 are in contact at the same time as an end of the color toner image formed on the transfer belt 105 reaches a point where the transfer belt 105 contacts the transfer roller 112. Thus, the color toner image is transferred onto the piece of paper S by a second transferring bias voltage when the piece of paper S passes between the transfer belt 105 and the transfer roller 112. The color toner image transferred onto the piece of paper S is fixed onto the piece of paper S by heat and pressure in the fixing unit 111, and then the formation of a color image is completed by discharging the piece of paper S through the discharging roller 117.

For subsequent printing, the first and second cleaning devices 106 and 109, respectively, remove remaining unused toner from the photosensitive medium 101, the transfer belt 105, and the erasing lamp 107 to remove a charge remaining on the photosensitive medium 101 by irradiating the photosensitive medium 101.

A developing unit driving device 200 according to an embodiment of the present invention will now be described with reference to the accompanying drawings.

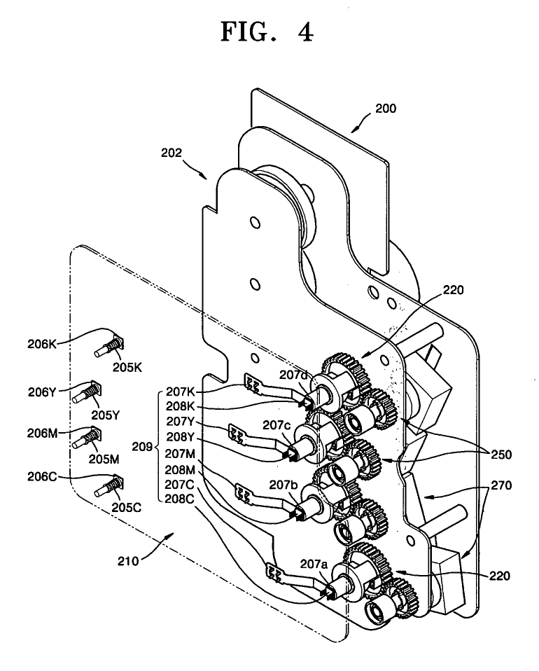

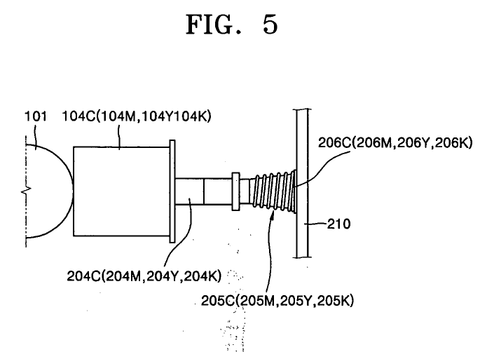

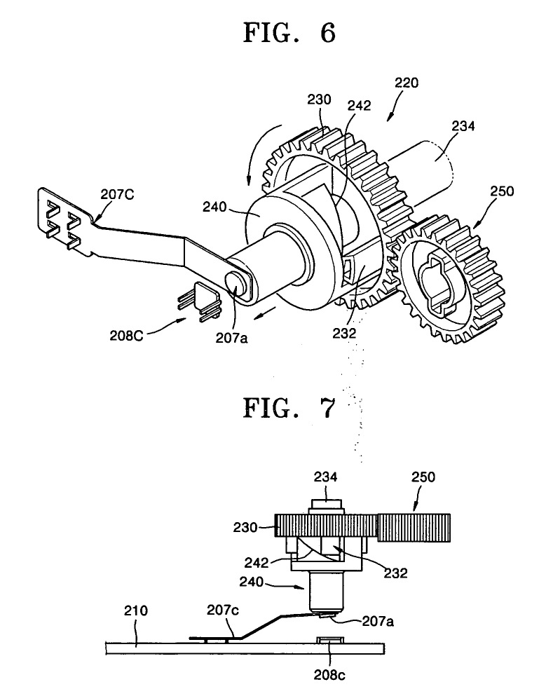

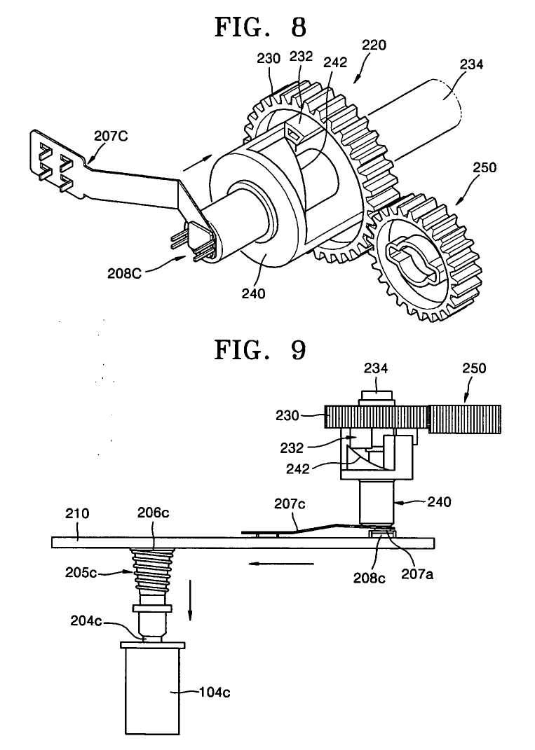

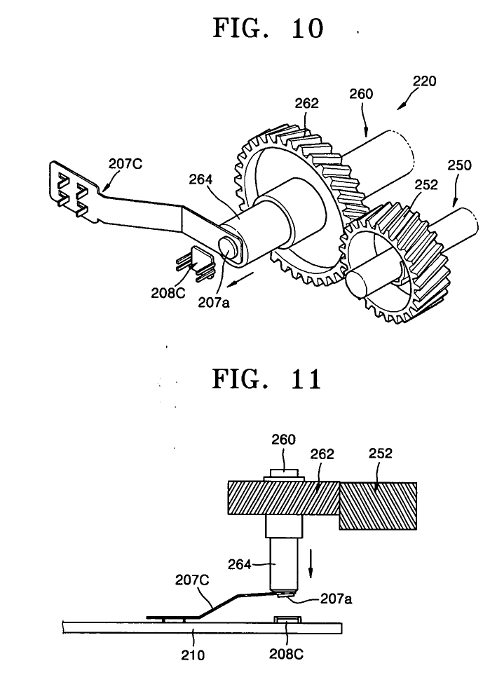

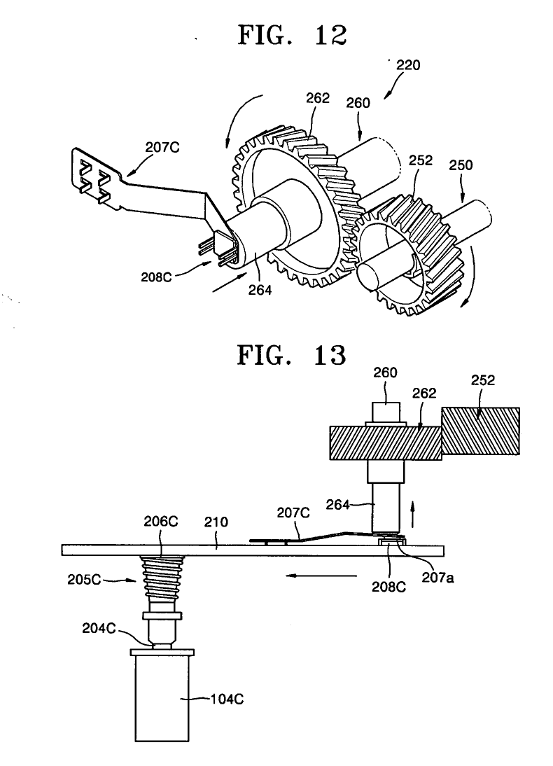

FIG. 4 is a perspective view of a developing unit driving device according to an embodiment of the present invention. FIG. 5 is a schematic drawing showing a connection state between a high voltage applying substrate of FIG. 4 and a developing unit. FIG. 6 is a perspective view of the reciprocating pusher unit of FIG. 4. FIG. 7 is a plan view of the reciprocating pusher unit of FIG. 6 and FIG. 8 is a perspective view showing an operation of the reciprocating pusher unit of FIG. 6. FIG. 9 is a plan view of the reciprocating pusher unit of FIG. 8, FIG. 10 is a perspective view of another example of the reciprocating pusher unit of FIG. 4, FIG. 11 is a plan view of the reciprocating pusher unit of FIG. 10, FIG. 12 is a perspective view showing an operation of the reciprocating pusher unit of FIG. 10, and FIG. 13 is a plan view of the reciprocating pusher unit of FIG. 10.

Referring to FIG. 4, the developing unit driving device 200 develops an electrostatic latent image formed on a photosensitive medium 101 into a predetermined color by selectively driving a plurality of developing units 104C, 104M, 104Y, and 104K. The developing unit driving device 200 includes a high voltage applying substrate 210, a reciprocating pusher unit 220, a power transmission unit 250, and a power control unit 270.

Referring to FIG. 5, high voltage applying terminals 204C, 204M, 204Y, and 204K are formed on a side of each of the developing units 104C, 104M, 104Y, and 104K. The high voltage applying terminals 204C, 204M, 204Y, and 204K, and terminals 206C, 206M, 206Y, and 206K, are preferably closely contacted by spring terminals 205C, 205M, 205Y, and 205K for stable contact.

The high voltage applying substrate 210 is mounted on a side of the developing units 104C, 104M, 104Y, and 104K. Referring to FIG. 4, the high voltage applying substrate 210 includes a high voltage circuit connected to a high voltage power supply unit 108. The high voltage applying substrate 210 includes terminals 206C, 206M, 206Y, and 206K connected to the high voltage applying terminals 204C, 204M, 204Y, and 204K, and switches 209 that disconnect high voltages transmitted from the outside to the developing units 104C, 104M, 104Y, and 104K by being connected to the terminals 206C, 206M, 206Y, and 206K and the high voltage circuit. The switches 209 include first terminals 207C, 207M, 207Y, and 207K connected to the terminals 206C, 206M, 206Y, and 206K, and second terminals 208C, 208M, 208Y, and 208K connected to the high voltage circuit. Here, the first terminals and the second terminals are disposed a predetermined distance apart to form pairs. The terminals 206C, 206M, 206Y, and 206K are preferably mounted on a side of the high voltage applying substrate 210, and the first terminals 207C, 207M, 207Y, and 207K and the second terminals 208C, 208M, 208Y, and 208K are preferably mounted on the other side of the high voltage applying substrate 210 in order to leave a space for forming the developing units 104C, 104M, 104Y, and 104K.

A plurality of components included in each of the developing units 104C, 104M, 104Y, and 104K will now be described. For clarity and convenience, the following description will focus on components included in the cyan C developing unit 104C, since the developing units 104C, 104M, 104Y, and 104K all have the same components.

A side of the first terminal 207C is fixed to the high voltage applying substrate 210 connected to the terminal 206C. A contact end part 207a, corresponding to the second terminal 208C, is formed on the other side of the first terminal 207C. The contact end part 207a moves into and out of contact with the second terminal 208C by a reciprocating pusher unit which will be described later. When the contact end part 207a contacts the second terminal 208C, the first terminal 207C and the second terminal 208C are electrically connected. When the first terminal 207C and the second terminal 208C are electrically connected, a developing bias voltage is applied to the corresponding developing unit 104C by the high voltage power supply unit 108. When the developing bias voltage is applied to the developing roller 125 mounted on the developing unit 104C, the developing unit 104C supplies toner adhering to the outer surface to the photosensitive medium 101. The first terminal 207C is preferably formed of a contact spring since the first terminal 207C must contact and separate from the second terminal 208C.

FIGS. 6 through 9 are drawings illustrating a reciprocating pusher unit 220 according to an embodiment of the present invention.

Referring to FIG. 6, the reciprocating pusher unit 220 includes a first member 230, to which power is transmitted from a power transmitting unit 250 which will be described later, and a second member 240 that allows the first terminal 207C to contact and separate from the second terminal 208C by interacting with the contact end part 207a. The first member 230 rotates in a predetermined direction by coupling with an axis 234 in connection with the power transmitting unit 250. A protrusion 232 protrudes toward the second member 240 and is formed on an inner surface of the first member 230. Here, the first member 230 and the power transmitting unit 250 are operatively connected to each other and a gear is preferably mounted where power is directly transmitted. That is, the first member 230 is preferably a gear.

The second member 240 is mounted on the same axis as the first member 230, and slides back and forth parallel to the axis 234 in connection with the first member 230. The second member 240 can be slidably mounted on a hub unit for movement along the axis 234, or can be mounted directly on the axis 234 to slide freely thereon. In this manner, the second member 240 can be mounted in various ways on the axis 234 and the embodiments of the present invention are not limited thereto. The second member 240 interacts with the contact end part 207a by sliding back and forth along the axis 234 in connection with the first member 230 so that the first terminal 207C can selectively contact the second terminal 208C. A high voltage is applied to the corresponding developing unit 104C when the first terminal 207C contacts the second terminal 208C via extension of the second member 240. The first terminal 207C is electrically disconnected from the second terminal 208C when the first terminal 207C separates from the second terminal 208C by reciprocation of the second member 240. A cam lobe 242 is formed with a slope in the moving direction of the second member 240 on an inner surface of the second member 240 corresponding to the protrusion 232 formed on an inner surface of the first member 230. The protrusion 232 is pushed by the cam lobe 242 to slide when the first member 230 rotates. Thus, the sliding cam lobe 242 pushes the second member 240 toward the contact end part 207a until the first terminal 207C contacts the second terminal 208C. When developing is completed by the developing unit 104C, a power control unit 270, which will be described later, disconnects power for developing by other developing units. At this time, the second member 240 moves back toward the first member 230 by an elastic restoration force, so that the first terminal 207C separates from the second terminal 208C.

Driving of the reciprocating pusher unit 220 of a developing unit driving device according to an embodiment of the present invention will now be described with reference to the drawings.

First, when the charge roller 102 charges the photosensitive medium 101 to a uniform potential, a light scanning unit 103 forms an electrostatic latent image to be developed into a first color on an outer surface of the photosensitive medium 101 by scanning with light. The case of developing cyan color will be explained as a representative example. The power control unit 270 transmits power to the power transmitting unit 250 for driving a corresponding developing unit, that is, the developing unit 104C. At this time, as depicted in FIGS. 6 and 7, the first member 230 rotates in a predetermined direction, and the protrusion 232 formed on the inner surface of the first member 230 allows the second member 240 to slide toward the contact end part 207a by interacting with the cam lobe 242 formed on the inner surface of the second member 240. As depicted in FIGS. 8 and 9, the second member 240 interacts with the contact end part 207a so that the first terminal 207C and the second terminal 208C come into contact and are electrically connected with each other. At this time, as depicted in FIG. 9, when a high developing bias voltage is applied by the high voltage power supply unit 108, the high developing bias voltage is supplied to the high voltage applying terminal 204C included in the developing unit 104C through the high voltage circuit, the second terminal 208C, the first terminal 207C, terminal 206C, and the corresponding color is developed. When the developing of cyan is completed, the high voltage power supply unit 108 disconnects the high voltage, and the power control unit 270 also disconnects power to the power transmitting unit 250. As depicted in FIGS. 6 and 8, the second member 240 returns to its original location under the restoration force of the first terminal 207C. That is, the first terminal 207C separates from the second terminal 208C through the reverse of the process of applying a developing bias voltage. When developing by the cyan developing unit 104C is completed, the developing unit driving device 200 develops other colors by selectively driving other developing units 104M, 104Y, and 104K. The electrostatic latent image formed on the photosensitive medium 101 is developed into a visible color image through repeating the aforementioned process.

FIGS. 10 through 13 are drawings of another embodiment of the reciprocating pusher unit 220.

Referring to FIGS. 10 through 13, the power transmitting unit 250 includes a power transmission gear 252 that transmits power to the reciprocating pusher unit 220, and the reciprocating pusher unit 220 includes an axis 260, a driven gear 262, and an interaction unit 264.

The driven gear 262 is mounted on the axis 260. The driven gear 262 is geared with the power transmission gear 252 and is preferably mounted to be able to slide back and forth along the axis 260. The driven gear 262 can be mounted on a hub unit mounted to be able to slide along the axis 260 or can be mounted directly on the axis 260 to slide freely thereon. The driven gear 262 can be mounted in various ways on the axis 260 and the present invention is not limited to the embodiments disclosed herein. The interaction unit 264 is formed by a protrusion on a side of the driven gear 262 and interacts with the contact end part 207a so that the first terminal 207C can selectively contact the second terminal 208C.

As described above, the driven gear 262 is mounted to slide along the axis 260 and interacts with the contact end part 207a in connection with the rotation of the power transmission gear 252. Accordingly, the interaction unit 264 included in the driven gear 262 interacts with the contact end part 207a so that the first terminal 207C can contact the second terminal 208C. At this time, the first terminal 207C can separate the interaction unit 264 from the second terminal 208C by the restoration force of the first terminal 207C.

As described above, the driven gear 262 and the power transmission gear 252 are preferably helical gears in order that the driven gear 262 can slide back and forth by the rotation of the power transmission gear 252. Since its teeth are sloped, the helical gear generates a thrust force parallel to the axis 260 when rotating. Therefore, the driven gear 262 slides back and forth under the thrust force from the rotation of the power transmission gear 252 when the power transmission gear 252 is fixed on the axis 260.

The reciprocating pusher units 220 of other developing unit driving devices are identical to, and thus are driven in exactly the same way as, that of the developing unit driving device depicted in FIGS. 6 through 9.

Referring to FIG. 4, the power transmitting unit 250 transmits power from an (external) power source (not shown) to the reciprocating pusher unit 220. Also, the power transmitting unit 250 transmits power for rotating the developing roller 125 mounted on the developing units 104C, 104M, 104Y, and 104K to the developing units 104C, 104M, 104Y, and 104K. That is, the power transmitting unit 250 transmits power for applying a developing bias voltage to the corresponding developing units 104C, 104M, 104Y, and 104K to the reciprocating pusher unit 220, and transmits power for mechanically rotating the developing roller 125 to the developing units 104C, 104M, 104Y, and 104K.

The power control unit 270 is provided between a power source (not shown) and the power transmitting unit 250. The power control unit 270 controls power for rotating the developing roller 125 and for driving the reciprocating pusher unit 220. The power control unit 270 may include an electronic clutch. A description of such an electronic clutch will be omitted since it is well known.

A driving unit 202 includes motors, gears, and axes for driving the developing units 104C, 104M, 104Y, and 104K including the power transmitting unit 250 and the power control unit 270. A description of the motors, gears, and axes mounted in the driving unit will be omitted for clarity and conciseness.

In the above image forming apparatus 100, the developing units 104C, 104M, 104Y, and 104K are mounted around the photosensitive medium 101, and the developing rollers 125 mounted in the developing units 104C, 104M, 104Y, and 104K and the photosensitive medium 101 are able to separate from each other by a predetermined distance or to contact each other. Here, the developing units 104C, 104M, 104Y, and 104K preferably separate a predetermined distance from the photosensitive medium 101 so that a toner image formed on the photosensitive medium 101 does not touch the other developing rollers 125.

Also, the developing unit driving device 200 selectively drives the developing units 104C, 104M, 104Y, and 104K and is described mainly with respect to the process for applying a high voltage to the developing units 104C, 104M, 104Y, and 104K.

According to the exemplary embodiments of the present invention, when a high voltage is applied to the developing units 104C, 104M, 104Y, and 104K, the high voltage can be applied to the developing units 104C, 104M, 104Y, and 104K without moving the photosensitive medium 101. Also, the high voltage applied to the developing units 104C, 104M, 104Y, and 104K can be selectively controlled using a power control unit 270 that connects or disconnects the rotation of the developing rollers 125 for sequential developing using the developing units 104C, 104M, 104Y, and 104K without additional devices, such as a motor, a cam, or a solenoid.

As described above, in a developing unit driving device according to the exemplary embodiments of the present invention and an image forming apparatus having the same, since a high voltage can be applied to the developing units in a stably fixed state without moving, load variations and vibrations which may affect the photosensitive medium are reduced, thereby improving image quality. Also, manufacturing costs can be reduced since the high voltage applied to the developing unit is controlled using a developing unit driving device for driving each of the developing units without additional devices. Also, work efficiency can be improved since additional wires for applying high voltage are unnecessary due to the high voltage circuit built into the high voltage applying substrate.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A developing unit driving device of an image forming apparatus that develops an electrostatic latent image formed on a photosensitive medium into predetermined colors by driving a plurality of developing units, the developing unit driving device, comprising:
a high voltage applying substrate that includes a high voltage circuit connected to a high voltage power supply unit;
a terminal unit connected to a high voltage applying terminal provided in each developing unit;
a switch that controls high voltage supplied from the outside connected to the terminal unit and the high voltage circuit, wherein the switch has first and second terminals corresponding to each other;
a reciprocating pusher unit that connects and separates the first terminal and the second terminal by interacting with an end of the first terminal;
a power transmitting unit that transmits power supplied from a power source to the reciprocating pusher unit in connection with the reciprocating pusher unit; and
a power control unit disposed between the power source and the power transmitting unit to control power transmitted to the corresponding developing unit.

2. The developing unit driving device of claim 1, wherein the first terminal is connected to the terminal unit and the second terminal is connected to the high voltage circuit.

3. The developing unit driving device of claim 2, wherein the first terminal includes a contact end part corresponding to the second terminal and the contact end part moves into and out of contact with the second terminal by the reciprocating pusher unit.

4. The developing unit driving device of claim 3, wherein the terminal unit is located on a side surface of the high voltage applying substrate and the first and second terminals are located on the other side surface of the high voltage applying substrate.

5. The developing unit driving device of claim 4, wherein the first terminal is a contact spring.

6. The developing unit driving device of claim 5, wherein the power control unit includes an electronic clutch.

7. The developing unit driving device of claim 3, wherein the reciprocating pusher unit includes:
a first member mounted on an axis that receives power from the power transmitting unit; and
a second member mounted on the same axis as the first member that interacts with the contact end part so that the first terminal can selectively contact the second terminal by sliding back and forth along the axis in connection with the first member.

8. The developing unit driving device of claim 7, wherein a cam lobe pushes the second member to the contact end part when the first member rotates via a protrusion formed on an inner surface of the first member and the cam lobe is formed on an inner surface of the second member corresponding to the protrusion.

9. The developing unit driving device of claim 8, wherein the first terminal reciprocates the second member by an elastic restoration force generated by elastically biasing the second member toward the first member.

10. The developing unit driving device of claim 9, wherein the terminal unit of the high voltage applying substrate and the high voltage applying terminal of the developing unit are closely connected by a spring terminal.

11. The developing unit driving device of claim 10, wherein the first member is a gear.

12. The developing unit driving device of claim 3, wherein the power transmitting unit includes a power transmission gear that transmits power to the reciprocating pusher unit, and the reciprocating pusher unit includes:
an axis;
a driven gear mounted on the axis that slides back and forth along the axis by gearing with the power transmission gear; and
an interaction unit protruding from a side of the driven gear that interacts with the contact end part so that the first terminal can selectively contact the second terminal.

13. The developing unit driving device of claim 12, wherein the power transmission gear and the driven gear are helical gears.

14. The developing unit driving device of claim 13, wherein the terminal unit of the high voltage applying substrate and the high voltage applying terminal of the developing unit are closely connected by a spring terminal.

15. The developing unit driving device of claim 14, wherein the developing units are mounted a predetermined distance apart from the photosensitive medium.

16. An image forming apparatus including a developing unit driving device that develops an electrostatic latent image formed on a photosensitive medium into predetermined colors by selectively driving a plurality of developing units, the developing unit driving device comprising:
a high voltage applying substrate that includes a high voltage circuit connected to a high voltage power supply unit;
a terminal unit connected to a high voltage applying terminal provided in each developing unit;
a switch that controls high voltage supplied from the outside connected to the terminal unit and the high voltage circuit, wherein the switch has first and second terminals corresponding to each other;
a reciprocating pusher unit that connects and separates the first terminal and the second terminal by interacting with an end of the first terminal;
a power transmitting unit that transmits power supplied from a power source to the reciprocating pusher unit in connection with the reciprocating pusher unit; and
a power control unit disposed between the power source and the power transmitting unit that controls power transmitted to the corresponding developing unit.

17. The image forming apparatus of claim 16, wherein the first terminal is connected to the terminal unit and the second terminal is connected to the high voltage circuit.

18. The image forming apparatus of claim 16, wherein the reciprocating pusher unit comprises:
a first member mounted on an axis that receives power from the power transmitting unit; and
a second member mounted on the same axis as the first member that interacts with the contact end part so that the first terminal can selectively contact the second terminal by sliding back and forth along the axis in connection with the first member.

19. The image forming apparatus of claim 18, wherein a cam lobe pushes the second member to the contact end part when the first member rotates via a protrusion formed on an inner surface of the first member and the cam lobe is formed on an inner surface of the second member corresponding to the protrusion.

20. The image forming apparatus of claim 16, wherein the power transmitting unit includes a power transmission gear that transmits power to the reciprocating pusher unit, and the reciprocating pusher unit includes:
an axis;
a driven gear mounted on the axis that slides back and forth along the axis by gearing with the power transmission gear; and
an interaction unit protruding from a side of the driven gear that interacts with the contact end part so that the first terminal can selectively contact the second terminal.
